(19) United States
(12) Patent Application Publication
(10) Pub. No.: US 2007/0202029 A1
(43) Pub. Date: Aug. 30, 2007

(54) Method Of Removing Impurities From Metallurgical Grade Silicon To Produce Solar Grade Silicon

(76) Inventors: Gary Burns, Midland, MI (US); James Rabe, Midland, MI (US); Sefa Yilmaz, Saginaw, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/580,945

(22) PCT Filed: Aug. 27, 2004
(86) PCT No.: PCT/US04/27846

§ 371 Date: Dec. 8, 2006

Related U.S. Application Data
(60) Provisional application No. 60/527,120, filed on Dec. 4, 2003.

(51) Int. Cl. C01B 33/00

(52) U.S. Cl. 423/324

(57) ABSTRACT

Metallurgical grade silicon is purified by removing metallic impurities and non-metallic impurities. The object is to produce a silicon species that is suitable for use as solar grade silicon. The process involves grinding metallurgical grade silicon containing metallic and non-metallic impurities to a silicon powder consisting of particles of silicon having a diameter of less than about 5 millimeter. While maintaining the ground silicon powder in the solid state, the ground silicon powder is heated to a temperature less than the melting point of silicon (1410° C.) under reduced pressure. The heated ground silicon powder is maintained at that temperature for a period of time sufficient to enable at least one metallic or non-metallic impurity to be removed from the metallurgical grade silicon.

### FIELD OF THE INVENTION

This invention is related to a method of removing impurities especially phosphorous, from metallurgical grade (MG) silicon to produce solar grade (SG) silicon. In particular, according to the invention, metallurgical grade silicon is treated while it is in the solid state, rather than in its molten state, as is the common practice according to prior methods. The metallurgical grade silicon remains in the solid state throughout the process.

### BACKGROUND OF THE INVENTION

In U.S. Pat. No. 5,182,091 (Jan. 26, 1993), phosphorus is removed by electron beam melting of silicon under vacuum, and boron is then removed by use of a plasma process. Each of the steps is followed by directional solidification for metal removal. U.S. Pat. No. 6,090,361 (Jul. 18, 2000) describes a method for purifying metallurgical grade silicon for solar cell use, by evaporating phosphorous from molten silicon under vacuum, followed by a directional solidification to remove Al, Fe, Ca, and Ti. Another directional solidification process is carried out after removing boron from molten silicon by oxidative purification. This second directional solidification step removes the remaining metallic impurities. Purified silicon is then produced in the form of an ingot. U.S. Pat. No. 6,231,826 (May 15, 2001) teaches that by pouring molten silicon between successive high purity, high density, graphite vessels under vacuum and electron beam heating, it is possible to remove phosphorus, Al, and Ca from silicon.

According to the present invention, however, a much higher surface area mass is provided for the evaporation of the phosphorus species from the fine silicon particles than the area available when the phosphorus sought to be removed is dissolved in a deep molten mass of silicon liquid. For example, a 50 kilogram (kg) portion of 100 micrometer (μm) diameter silicon powder with a specific surface area of 0.025 m²/g, would have a total surface area of 1250 m². In contrast, a 20 liter cubic shaped container with side dimensions of 0.27 meter would hold 50 kilogram of molten silicon. This would have a total surface area of only 0.073 m².

In addition, when scaled to higher quantities, the surface area to mass ratio does not change significantly according to the method of present invention, whereas it decreases dramatically according to prior methods employing molten silicon methodology, unless at least one dimension is increased to a point where practicality is compromised. Therefore, it is possible to scale methods according to the present invention to commercial quantities with more facility than by using prior art methods. Furthermore, it is possible to lower the content of metals such as Al, Ca, Mg, Mn, Sn, Zn, and Cu, up to two orders of magnitude after treatment.

### SUMMARY OF THE INVENTION

The invention is directed to a process of purifying silicon by removing metallic impurities and non-metallic impurities, especially phosphorous, from metallurgical grade silicon. The object is to produce a silicon species suitable for use as solar grade silicon. Basically, the process comprises the steps of (i) grinding metallurgical grade silicon containing metallic impurities and non-metallic impurities to a silicon powder consisting of particles of silicon having a diameter of less than about 5,000 micrometer (μm); (ii) while maintaining the ground silicon powder in the solid state, heating the ground silicon powder under vacuum to a temperature less than the melting point of silicon; and (iii) maintaining the heated ground silicon powder at said temperature for a period of time sufficient to enable at least one metallic or non-metallic impurity to be removed.

These and other features and details of the invention will become apparent from a consideration of the detailed description.

### BRIEF DESCRIPTION OF THE DRAWING

Not applicable.

### DETAILED DESCRIPTION OF THE INVENTION

This invention is directed to processes for removing impurities such as phosphorus from metallurgical grade silicon in order to produce a solar grade silicon suitable for use in the photovoltaic (PV) industry for preparing such devices as solar cell modules. As is known solar modules convert radiation from sun into electricity. However, in order to be suitable for use in the photovoltaic industry, the photovoltaic industry generally requires that metallurgical grade silicon which has a purity level of about 98-99 weight percent, be further purified to a purity level of 99.99-99.9999 weight percent.

Typically, the photovoltaic industry mandates that purification of metallurgical grade silicon include the removal of boron (B), phosphorus (P), oxygen (O), carbon (C), and various miscellaneous metals. Despite many efforts in the past 30 years, however, no commercially scaled and economic process has been available to upgrade metallurgical grade silicon to a silicon suitable for solar grade application. Some of the major problems for implementation of commercially scaled processes involve the removal of boron and phosphorous from metallurgical grade silicon in an economic manner. The present invention provides a viable solution to the phosphorous removal aspect in dealing with purification of metallurgical silicon suitable for use in the photovoltaic industry.

In contrast to the prior art methods, the process of this invention can effectively remove phosphorous from metallurgical grade silicon by treating it in a solid state rather than under molten conditions. Whereas in prior methods, molten silicon was treated under vacuum or in the presence of reactive gases, or molten silicon was heated by electron beam under vacuum, the method according to this invention simply grinds metallurgical grade silicon into a powder, and then heats the silicon powder under a vacuum at a temperature of about 1300° C. The temperature used must be a temperature below the melting point of silicon, i.e., below 1410° C.

Therefore, the essence and crux of the invention is that phosphorus is removed in its solid state as opposed to its liquid state, and the metallurgical grade silicon being purified remains in the solid form for the duration of the treatment process. This process has demonstrated ranges of removal efficiency of phosphorus from metallurgical grade silicon ranging from 50 percent to 76 percent after a treatment period of 36 hours, at a temperature of 1370° C., and under a total pressure of 0.5 Torr (66.66 Pa).

Basically, the process according to the invention is carried out by first grinding metallurgical grade silicon into a powder form consisting of particles of silicon having a diameter of less than about 5,000 micrometer (μm), preferably a diameter of less than about 500 micrometer (μm), and more preferably a diameter of less than about 125 micrometer (μm). It is believed that this grinding procedure enables one to significantly shorten the diffusion path of the metallic and non-metallic impurities from the metallurgical grade silicon.

The thusly ground silicon powder particles are then processed in one of two ways. First, the powder can be placed into trays, and evenly distributed in the trays in a uniform layer of less than one inch/2.54 cm, preferably a uniform layer of about 0.5 inch/1.27 cm, most preferably a uniform layer of 0.25 inch/0.6 cm. These trays are then placed into a vacuum furnace for a period of time sufficient to enable the removal of at least one impurity Generally, a period of several hours to a period of tens of hours is sufficient for this purpose. Second, instead of distributing the powder on a tray, a means of agitation can be provided while the powder is being exposed to the above temperature, pressure, and time conditions. For example, the agitation method can consist of rotating a retort in a vacuum furnace.

The conditions in the vacuum furnace are maintained at a temperature which can range from 1000° C. to a temperature less than the melting point of silicon, i.e., 1410° C., preferably a temperature ranging from 1300° C. to 1370° C., and most preferably a temperature of from 1330° C. to 1370° C. The pressure in the vacuum chamber is maintained at a pressure of less than 760 Torr/101,325 Pa, preferably a pressure of less than 0.5 Torr/66.66 Pa, most preferably a pressure of less than 0.01 Torr/1.33 Pa.

Oxidizing species in the gaseous atmosphere should be limited, such that the surface of the silicon remains under an active oxidation condition. If necessary, an inert gas should be added to maintain this condition. In the active oxidation mode, any oxygen striking the silicon surface will form silicon monoxide (SiO) gas, and no intact oxide layer will form. Optionally, some reactive gaseous atmospheres can be used to create a chemical potential difference between the impurities in silicon and the gas phase, to enhance removal of any impurities from silicon.

While the primary focus of the method according to this invention is to remove phosphorous from metallurgical grade silicon, other secondary metals and secondary non-metals that can be removed include elements such as aluminum, calcium, copper, magnesium, manganese, sodium, tin, and zinc, for example.

### EXAMPLES

The following examples are set forth in order to illustrate the invention in more detail.

Procedure

In the following examples, powdered silicon was prepared in a laboratory scale Bleuler Rotary Mill operating at 230 volt (V) and 60 hertz (Hz). The rotary mill was composed of a dish, a concentric circular piece that loosely fits into the dish, and a solid metal piece in the shape of a hockey puck that loosely fits inside the concentric piece. A centrifugal force shakes the whole puck set to grind silicon chunks into a powder. The sizes of the chunks are typically about one inch. The dish and puck set are made out of tungsten carbide alloy or carbon steel. The carbon steel dish set was used in these examples.

About 80 grams of silicon were ground to about 100 micrometer or finer diameter in less than about one minute. Once ground, the silicon was sieved by a CSC Scientific sieve shaker to obtain the desired particle size cuts. In the examples, the size cuts used were size cuts between 90-300 micrometer, i.e., No. 170 and No. 50 USA Standard mesh, or 125-300 micrometer, i.e., No. 120 and No. 50 USA Standard mesh. The specific particle size cuts used are denoted in the data Tables below.

During treatment, the silicon powder was contained in one of five types of crucibles. The first crucible was a shallow alumina crucible, 0.25 inch deep, 0.5 inch wide and oval in shape, manufactured by Coors Ceramics Company, Golden, Colo. The second crucible was a tall alumina crucible, 0.75 inch in diameter, 1.25 in height, cylindrical in shape, and also manufactured by Coors Ceramics Company. The third and forth crucibles were fused silica crucibles. The third fused silica crucible was 1.5 inch in diameter, 1.25 inch in height, and had an oval bottom. The fourth fused silica crucible was 5 inch in diameter, 5 inch in height, and had a flat bottom. Both the third and fourth fused silica crucibles were manufactured by Quartz Scientific, Inc., Fairport Harbor, Ohio. The fifth crucible was a molybdenum crucible, 0.75 inch in diameter, 0.375 inch in height, and had a flat bottom. It was manufactured by the R. D. Mathis Company, Long Beach, Calif.

A horizontal Lindberg Model 54434 furnace with a 2 inch inside diameter alumina tube was used for all of the examples. Water-cooled steel plates and rubber gaskets capped the ends of the alumina tube so that a vacuum could be created in the tube. A mechanical pump evacuated the tube down to the 0.2-0.5 Torr/26.66-66.66 Pa pressure ranges. Alternatively, the tube was purged with high purity argon and/or argon saturated with water vapor. A vacuum furnace manufactured by Centorr Vacuum Industries, Nashua, N.H., was used for treating the powders in the 5 inch diameter fused silica crucible, at pressures below 10⁻⁴ Torr/0.013 Pa. The vacuum furnace was furnished with a tungsten metal hot zone having dimensions of 6 inch in width, 6 inch in height, and 16 inch in depth. The vacuum furnace was also furnished with a rotary vane pump and a Varian diffusion pump.

For each treatment run, control and treated samples were analyzed for metals plus phosphorous and boron, by Inductively Coupled Plasma-Mass Atomic Emission Spectroscopy (ICP-AES). The results are summarized in Tables 1-3. The Tables show the results before and after treatment of metallurgical grade silicon powder.

### Example 1

According to this example, several runs relating to the removal of phosphorus from silicon, were carried out using the method according to the present invention, and are summarized below and set forth in Table 1. The data shows results obtained using different treatment atmospheres. Column 1 in Table 1 provides the analysis of the silicon powder used as the starting material for the treated samples shown in Columns 2-4. When the process is maintained at about 1,370° C. for 36 hours, phosphorus can be removed from silicon at a removal efficiency of about 23 percent, under a 760 Torr (10,1325 Pa) argon atmosphere, i.e., Table 1, Column 2, and at a removal efficiency of about 76 percent, at a pressure of 0.5 Torr (66.66 Pa), i.e., Table 1, Column 3. Lower total pressure conditions resulted in much better phosphorus removal efficiency. Table 1 also shows that significant removal was also obtained for impurities such as calcium, copper, magnesium, manganese, sodium, tin, and zinc. The increase in the aluminum concentration during these treatments was due to contamination from the alumina crucible, and this is shown in Example 2. On the other hand, no phosphorus was removed when the treatment atmosphere contained 3-mole percent steam in argon, i.e., Table 1, Column 4, which constitute conditions under which an intact oxide layer is believed to form.

TABLE 1
Summary of Data Pertaining to Phosphorus (P) Removed
from Silicon at Different Treatment Atmospheres

| | Conditions | | | |
|---|---|---|---|---|
| | 1 | 2 | 3 | 4 |
| | Starting Material | Treated | Treated | Treated |
| Particle Size | 90-300 (μm) | 90-300 (μm) | 90-300 (μm) | 90-300 (μm) |
| Temp. ° C. | — | 1,370 | 1,370 | 1,370 |
| Time, hours | — | 36 | 36 | 36 |
| Atmosphere | — | Argon | 0.2-0.5 Torr | Steam/Argon |
| Configuration | — | 0.2 inch thick | 0.2 inch thick Al₂O₃ | 0.2 inch thick |
| Details | | Al₂O₃ boat | boat | Al₂O₃ boat |
| Al | 1,663 | 6,164 | 5,808 | 1,634 |
| Ca | 465 | 231 | 15 | 452 |
| Cu | 73 | 69 | <0.5 | 68 |
| Mg | 11.3 | 0.6 | 0.6 | 8.2 |
| Mn | 152 | 117 | <0.5 | 140 |
| Na | 12 | 4.7 | 4.0 | 49.0 |
| P | 47 | 36 | 11 | 50 |
| Sn | 2.8 | <2 | <2 | <2 |
| Zn | 10 | 1.7 | 3.8 | 3.3 |

It can be seen in Table 1 that the removal efficiency for phosphorus was about 23-76 percent for powder samples treated at 1,370° C. under a vacuum, and in layers on trays having a depth of about 0.2 inch/0.5 cm. The higher removal efficiency, i.e., 76 percent, was achieved when higher initial phosphorous concentrations were present in the powder samples. It is believed that in the case of phosphorous, the element diffuses out from the metallurgical grade silicon particles due to a concentration gradient created between the particle surface and its bulk. According to the diffusion theory, the removal rate increases as the concentration gradient increases.

### Example 2

This example shows how the selection of crucible composition can affect the product impurity content. Columns 2 and 3 in Table 2 show the impurity contents present after the powder described in Column 1 of Table 2 was treated for 36 hours at 1,330° C. under 0.5 Torr (66.66 Pa) pressure in either an alumina or a fused silica crucible. The sample treated in alumina, i.e., Table 2, Column 2, showed a substantial reduction in calcium, copper, manganese, phosphorus, and zinc content, but the aluminum content increased. In contrast, the sample treated in the fused silica, i.e., Table 2, Column 3, showed a large decrease in aluminum content, along with reductions in other elements similar to those seen with the alumina crucible. This illustrates that the method of the present invention is also effective in removing aluminum from silicon, when the proper materials of construction are selected. The term <DL in Table 2 Column 4 for copper means that the amount was less than the Detection Limit, below which quantification of the concentration of copper is not reliable.

TABLE 2
Summary of Data Showing How the Choice of Crucible Composition
Affects Impurity Concentration in Silicon

| | Conditions | | |
|---|---|---|---|
| | 1 | 2 | 3 |
| | Starting Material | Treated | Treated |
| Particle size | | 125-300 (μm) | 125-300 (μm) |
| Temp. ° C. | — | 1,330 | 1,330 |
| Time, hours | — | 36 | 36 |
| Atmosphere | — | 0.2-0.5 Torr | 0.2-0.5 Torr |
| Configuration Details | — | 1 inch thick in Al₂O₃ | 1 inch thick in SiO₂ |
| Al | 1,624 | 11,220 | 165 |
| Ca | 327 | 4.3 | 20 |
| Cu | 68 | 27 | <DL |
| Mg | — | — | — |
| Vm | 117 | 13 | 1.1 |
| Na | 3.2 | 3.7 | 5.2 |
| P | 45 | 23 | 24 |
| Sn | — | — | — |
| Zn | 5.4 | 0.1 | 0.1 |

### Example 3

This example illustrates the effect of shorter treatment times on the impurity removal efficiency. Column 1 in Table 3 shows the analysis of a silicon powder with a particle size of less than 180 micrometer that was used as the starting material for the sample in Column 2. It was treated at 1,370° C. under a pressure of 0.5 Torr (66.66 Pa) for 7 hours. Column 3 in Table 3 shows the analysis of a silicon powder with a particle size of less than 300 micrometer that was used as the starting material for the sample in Column 4. It was treated at 1,370° C. under a pressure of 0.5 Torr (66.66 Pa) for 20 hours. In comparison with the 36 hour treatment shown in Column 3 of Table 1, the phosphorus removal efficiency was progressively lower as the treatment time was reduced. However, even the 7 hour treatment reduced the phosphorus content by about 42 percent.

TABLE 3
Data Showing the Effect of Time on Impurity Removal for Higher
Purity and Lower Purity Metallurgical Grade Silicon Powders.

| | Conditions | | | |
|---|---|---|---|---|
| | 1 | 2 | 3 | 4 |
| | Starting Material | Treated | Starting Material | Treated |
| Particle Size | <180 (μm) | <180 (μm) | <300 (μm) | <300 (μm) |
| Temp. ° C. | — | 1,370 | — | 1,370 |
| Time, hours | — | ˜7 | — | 20 |
| Atmosphere | — | 0.2-0.5 Torr | — | 0.2-0.5 Torr |
| Configuration | — | ¼ inch thick Mo | — | ¼ inch thick Mo |
| Details | | Crucible | | Crucible |
| Al | 12 | 20 | 7.0 | 9.8 |
| Ca | 11 | 6.6 | 6.9 | 6.2 |
| Cu | 3.6 | 0.6 | 1.3 | 0.3 |
| Mg | — | — | — | — |
| Mn | 0.2 | 0.1 | 0.1 | <0.04 |
| Na | <6.9 | <4.7 | <6.0 | <4.7 |
| P | 8.6 | | 9.0 | <4.6 |
| Sn | — | — | — | — |
| Zn | 1.3 | 0.9 | 1.1 | 0.7 |

Table 3 shows that the removal efficiency for phosphorus was in excess of 47 percent in 20 hours of treatment, and that a significant removal was also obtained for impurities such as calcium, copper, magnesium, manganese, sodium, and zinc.

### Example 4

This example shows the impact of the temperature on the removal efficiency for phosphorus and for other impurities. Table 4 in Column 2 shows the impurities remaining after a one inch thick layer of the silicon powder described in Column 1 was treated for 36 hours at 900° C. under 0.5 Torr (66.66 Pa) pressure. No removal of impurities was observed under these conditions with the exception of zinc.

TABLE 4
Data Showing the Effect of Temperature
on Phosphorus Removal Efficiency

| | Conditions | |
|---|---|---|
| | 1 | 2 |
| | Starting Material | Treated |
| Particle Size | 0-300 (μm) | 0-300 (μm) |
| Temp. ° C. | — | 900 |
| Time, hours | — | 8 |
| Atmosphere | — | 0.2-0.5 Torr |
| Configuration Details | — | 1 inch thick in Al₂O₃ |
| Al | 73 | 73 |
| Ca | 56 | 53 |
| Cu | 2.9 | 3.0 |
| Mg | 1.2 | <1 |
| Mn | 6.6 | 6.3 |
| Na | 9.6 | 4.4 |
| P | 13 | 12 |
| Sn | 3.8 | 4.2 |
| Zn | 2.4 | 0.7 |

### Example 5

This example shows the impact of the particle size on phosphorus removal efficiency. Column 1 in Table 5 shows the initial impurity levels in a silicon powder sample that had a particle size of 90-150 micrometer. Column 3 in Table 5 shows the initial impurity levels in a silicon powder sample with a particle size of less than 45 micrometer. Both powders were treated for 36 hours at 1,370° C. under less than 10⁻⁴ Torr (0.013 Pa) total pressure. The powders were sampled from locations which were 0.75 inch/1.91 cm below the surface of the treated layer. The phosphorus removal efficiency was better for the sample having a size of less than 45 micrometer, i.e., Column 4 in Table 5, than for the sample having a size of 90-150 micrometer, i.e., Column 2 in Table 5.

TABLE 5
Data Summarizing the Effect of Particle Size
on the Impurity Removal from Silicon Powder

| | Conditions | | | |
|---|---|---|---|---|
| | 1 | 2 | 3 | 4 |
| | Starting Material | Treated | Starting Material | Treated |
| Particle Size | 90-150 (μm) | 90-150 (μm) | <45 (μm) | <45 (μm) |
| Temp. ° C. | | 1,370 | | 1,370 |
| Time, hours | | 36 | | 36 |
| Atmosphere | | <10⁻⁴ Torr | | <10⁻⁴ Torr |
| Configuration | — | ˜0.75 inch deep in | — | ˜0.75 inch deep |
| Details | | SiO₂ Crucible | | in SiO₂ Crucible |
| Al | 43 | 32 | 53 | 9.3 |
| Ca | 24 | 8.0 | 22 | 3.2 |
| Cu | 15 | 4.4 | 23 | 1.0 |
| Mg | — | <0.5 | — | <0.5 |
| Mn | 6.0 | 1.2 | 11 | <0.5 |
| Na | 8.8 | 4.7 | 6.1 | 4.3 |
| P | 16 | 18 | 16 | 8.0 |
| Sn | — | <2 | — | <2 |
| Zn | 0.8 | <0.5 | 1.6 | <0.5 |

The up-grading of metallurgical grade silicon offers an optional means for producing a low cost supply for solar grade silicon which is used for solar cell manufacturing. As noted above, in order to provide a viable avenue, one skilled in the art needs to lower most impurities in metallurgical grade silicon from several thousands of parts per million by weight (ppmw) to less than 1 ppmw. The impurities in transition metals such as chromium, copper, iron, manganese, molybdenum, nickel, titanium, vanadium, tungsten, and zirconium, are easier to remove by segregation methods because of their relatively lower segregation coefficients.

However, elements such as phosphorus and boron present unique problems and require unique solutions. It can be seen from the foregoing, that while the invention is especially focused at solving the problem as it relates to removal of phosphorus from metallurgical grade silicon, it not only will successfully remove phosphorous, but several other impurities as well, from the solid state of metallurgical grade silicon. As indicated, the method has several advantages over the current state of the art molten state phosphorous removal protocol.

Other variations may be made in compounds, compositions, and methods described herein without departing from the essential features of the invention. The embodiments of the invention specifically illustrated herein are exemplary only and not intended as limitations on their scope except as defined in the appended claims.

1. A process of purifying silicon by removing metallic impurities and non-metallic impurities from metallurgical grade silicon to produce a silicon suitable as solar grade silicon, comprising the steps of (i) grinding metallurgical grade silicon containing metallic impurities and non-metallic impurities to a silicon powder consisting of particles of silicon having an average diameter of less than about 5 millimeter; (ii) while maintaining the ground silicon powder in the solid state, heating the ground silicon powder to a temperature less that the melting point of silicon under reduced pressure; and (iii) maintaining the heated ground silicon powder at said temperature for a period of time sufficient to enable at least one metallic or non-metallic impurity to be removed.

2. The process according to claim 1 in which the temperature is between about 1000° C. to a temperature less than 1410° C.

3. The process according to claims 1 or 2, in which the impurity is phosphorous.

4. The process according to claims 1, 2, or 3, in which the particles of silicon have a diameter less than about 5 millimeter.

5. The process according to claims 1, 2, 3, or 4, in which the pressure of the treatment atmosphere is less than about 0.5 Torr/66.66 Pa.

6. The process according to claims 1, 2, 3, 4, or 5, in which the ground silicon powder is placed in trays and evenly distributed in a layer during heating.

7. The process according to claims 1, 2, 3, 4, or 5, wherein the ground silicon powder is placed on a stationary belt during heating.

8. The process according to claims 1, 2, 3, 4, or 5, wherein the ground silicon powder is agitated during heating.

9. The process according to claim 8, wherein the ground silicon powder is agitated in a rotating retort.

10. The process according to claim 8, wherein the ground silicon powder is agitated on a vibrating belt.

11. The process according to claim 8, wherein the ground silicon powder is agitated in a fluidized bed.
